(19) United States
(12) Patent Application Publication
(10) Pub. No.: US 2017/0186086 A1
(43) Pub. Date: Jun. 29, 2017

(54) Synthetic Cross-Currency Basis Swap Apparatuses, Methods, and Systems

(71) Applicant: Credit Suisse Securities (USA) LLC, New York, NY (US)

(72) Inventor: Jonathan Campbell, New York, NY (US)

(21) Appl. No.: 15/392,782

(22) Filed: Dec. 28, 2016

Related U.S. Application Data
(60) Provisional application No. 62/272,236, filed on Dec. 29, 2015.

(51) Int. Cl. G06Q 40/04; G06Q 20/38

(52) U.S. Cl. CPC G06Q 40/04; G06Q 20/381

(57) ABSTRACT

A processor-implemented method for executing a synthetic cross-currency basis swap, including determining a notional value for the swap, the notional value being denominated in a first currency; calculating a synthetic spread based on a spot rate between the first currency and a second currency, a first reference rate for the first currency, and a second reference rate for the second currency; calculating a first payment to be paid by a first party to the swap by multiplying the notional value by a predetermined number of basis points; calculating a second payment to be paid by a second party to the swap by multiplying the notional value by the synthetic spread; and facilitating an exchange of payment between the first party and the second party.

### FIELD

The present invention is directed generally to methods and systems for creating financial instruments. More particularly, the invention is directed to SYNTHETIC CROSS-CURRENCY BASIS SWAP APPARATUSES, METHODS, AND SYSTEMS (hereinafter SCCBS).

### BACKGROUND

Cross-currency basis swaps are commonly used to exchange floating liabilities in one currency for another. For example a company with operations in many countries or regions may use cross-currency basis swaps to match assets and liabilities held in different currencies as a way to reduce exposure to foreign exchange fluctuations from international operations.

### SUMMARY

A system for executing a synthetic cross-currency basis swap is disclosed. The system includes: a synthetic swap controller having a processor and a memory, a synthetic spread module, a payment module, and a payment facilitator. The synthetic swap controller may be configured to interface with the other modules and the facilitator through a communications network. The controller may be configured to determine a notional value for the swap denominated in a first currency. The synthetic spread module may be configured to calculate a synthetic spread based on a spot rate between the first currency and a second currency, a first reference rate for the first currency, and a second reference rate for the second currency. The payment module may be configured to calculate a first payment to be paid by a first party to the swap by multiplying the notional value by a predetermined number of basis points, and may be configured to calculate a second payment to be paid by a second party to the swap by multiplying the notional value by the synthetic spread. The payment facilitator may be configured to facilitate the exchange of payment between the first party and the second party.

A processor-implemented method for executing a synthetic cross-currency basis swap is also disclosed. The method includes determining, using a processor, a notional value for the swap, the notional value being denominated in a first currency; calculating, using the processor, a synthetic spread based on a spot rate between the first currency and a second currency, a first reference rate for the first currency, and a second reference rate for the second currency; calculating, using the processor, a first payment to be paid by a first party to the swap by multiplying the notional value by a predetermined number of basis points; calculating, using the processor, a second payment to be paid by a second party to the swap by multiplying the notional value by the synthetic spread; and facilitating, using the processor, an exchange of payment between the first party and the second party.

A processor-readable tangible physical medium storing processor-generated instructions to execute a synthetic cross-currency basis swap is also disclosed. The medium may include instructions to determine a notional value for the swap, the notional value being denominated in a first currency; calculate a synthetic spread based on a spot rate between the first currency and a second currency, a first reference rate for the first currency, and a second reference rate for the second currency; calculate a first payment to be paid by a first party to the swap by multiplying the notional value by a predetermined number of basis points; calculate a second payment to be paid by a second party to the swap by multiplying the notional value by the synthetic spread; and facilitate an exchange of payment between the first party and the second party.

### BRIEF DESCRIPTION OF THE DRAWINGS

The accompanying drawings illustrate various non-limiting, example, inventive aspects in accordance with the present disclosure:

FIG. 1 shows an example of a cross-currency basis swap;

FIG. 2 shows one exemplary implementation of a synthetic cross-currency basis swap according to SCCBS operation;

FIG. 3 shows a schematic illustration of data flows between SCCBS components and affiliated entities in one embodiment of SCCBS operation;

FIG. 4 shows aspects of SCCBS architecture in block-diagram form and data flow between and among SCCBS components in one embodiment of SCCBS operation;

FIG. 5 is a block diagram illustrating embodiments of the SCCBS controller.

### DETAILED DESCRIPTION

### SCCBS

This disclosure describes synthetic cross-currency basis swap apparatuses, methods, and systems (SCCBS) as well as associated financial products. Depending on the particular needs and characteristics of SCCBS users and their systems, various embodiments of the SCCBS may be implemented that enable a great deal of flexibility and customization.

A cross-currency basis swap is a floating-for-floating exchange of interest rate payments and notional amounts in two different currencies. Basis swaps may be used to swap issuance back to the currency of choice after receiving more favorable funding in a foreign market. The floating rate for each currency may be based on a reference rate in each currency.

For example, the floating rate may be tied to the London Interbank Offered Rate (LIBOR), which is a benchmark rate that leading banks charge each other for short-term loans. LIBOR is administered by the ICE Benchmark Administration (IBA), and is based on five currencies: U.S. dollar (USD), Euro (EUR), pound sterling, Japanese yen, and Swiss franc, and serves seven different maturities: overnight, one week, and one, two, three, six, and twelve months. The most commonly used rate is the three-month U.S. dollar rate (3m USD LIBOR). Another common reference rate is the Euro Interbank Offered Rate (Euribor), which is published by the European Banking Federation and is based on the average of interest rates at which European banks offer to lend unsecured funds to other banks in the wholesale money market. Euribor also serves several different maturities, including the 3-month Euro Rate (3m Euribor).

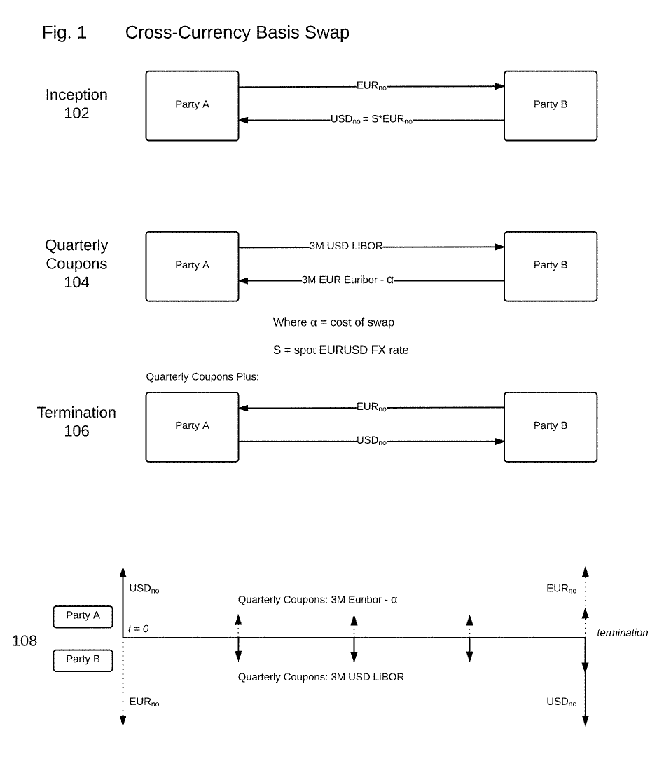

In a swap involving U.S. dollars and Euros, an investor may pay the 3m USD LIBOR and receive 3m Euribor plus a spread. FIG. 1 illustrates one example of a cross-currency basis swap between two parties. As shown at 102 in FIG. 1, at inception of the swap, Party A pays to Party B the EUR notional (for example, EUR 100), and Party B pays to Party A the starting USD notional (for example, USD 110, which may be the EUR notional times the EUR/USD spot FX rate), on an effective date marking the beginning of the swap.

As shown at 104 in FIG. 1, quarterly coupons are paid on each quarterly payment date during the lifetime of the swap (for example, quarterly anniversaries from the effective date, including the termination date). For example, on each quarterly payment date, the following may occur: (1) Party A pays USD interest equal to the prior quarter's USD notional multiplied by USD LIBOR as set at the beginning of the prior quarter. This payment amount is annualized to account for the number of days in the quarter. (2) Party B pays EUR interest equal to the prior quarter's EUR notional multiplied by the Euribor rate set at the beginning of the prior quarter, minus a contractual “spread” representing the fees for the transaction, for example, 30 basis points. This payment amount may be annualized to account for the number of days in the quarter.

In addition to the coupon payments, resetting of the USD notional amount may occur as follows: (1) the USD notional is reset to the then-current spot exchange rate between U.S. dollars and Euros (EUR/USD spot FX rate) multiplied by the EUR notional; (2) If the newly reset USD notional exceeds the notional from the prior quarter, Party B pays to Party A the absolute value of the difference between the two notionals. If the newly reset USD notional is lower than the notional from the prior quarter, Party A pays to Party B the absolute value of the difference between the two notionals.

As shown at 106 in FIG. 1, at a termination date, two additional cashflows may take place: first, the same quarterly coupon payment as described above is made, and second, Party B pays to Party A the EUR notional, and party A pays to Party B the USD notional as reset at the beginning of the last quarter. An overview of the entire process, is shown in a timeline 108 in FIG. 1.

A cross-currency basis swap is used to hedge cross-currency basis risk, but a byproduct a cross-currency basis swap is the incursion of significant counterparty credit exposure to spot foreign-exchange gap risk. For example, in the scenario described above, if Party B defaults and the EUR/USD appreciates 5%, Party A's incurred credit exposure is 5% of the notional. The SCCBS addresses this counterparty credit risk of the cross-currency basis swap, among other things, by creating a product where one party pays a fixed interest rate throughout the life of the trade, and the other party pays a floating interest rate equal to the opposite of the cross-currency basis spread implied by the spot and forward foreign exchange rates, and the three-month LIBOR and Euribor interest rates.

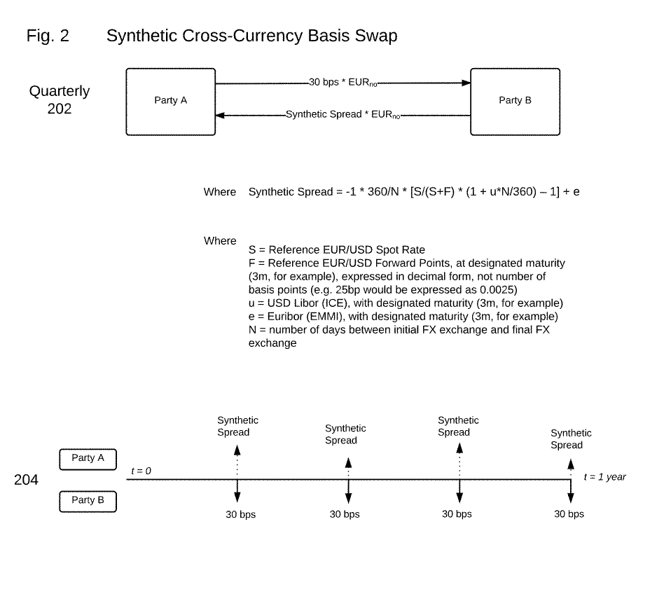

FIG. 2 illustrates one exemplary embodiment of the SCCBS. The SCCBS differs from the cross currency basis swap described above in that all payments are conducted in a single currency, and hence there are no “back-end” exchanges of notional values in different currencies at the end of the swap. The trade may be structured as a fixed-for-floating swap in the trade currency, for example, the non-USD currency in a given cross-currency pair

In one exemplary embodiment, the floating rate is equal to −1 multiplied by the implied three-month cross currency basis spread on each fixing date; market tradeable instruments are used to imply that spread. By structuring the trade this way, the significant mark-to-market fluctuations and the resulting counterparty credit risk that large back-end exchanges usual entail are eliminated. FIG. 2, as well as the description below shows what payments would be for an exemplary EUR/USD SCCBS. However, like a normal cross-currency basis swap, an SCCBS may be structured to involve any two currencies, not just EUR and USD. In one exemplary embodiment, all cash flows are conducted in one of the two currencies, represented by EUR in the examples shown.

As shown in FIG. 2 at 202, in one exemplary embodiment of the SCCBS, only a EUR notional is used. On each designated payment date through the life of the trade, including the termination date, the following payments may take place: (1) Party A pays a predetermined fixed rate (30 basis points, for example) multiplied by the EUR notional to Party B. This payment amount may be annualized to account for the number of days in the payment period. (2) Party B pays a synthetic three-month cross currency basis spread (synthetic spread) multiplied by the EUR notional to Party A (This formula actually represents −1 multiplied by the EUR/USD cross currency basis spread. The reason is so that, in this exemplary embodiment, both sides' spreads—30 bps and the synthetic spread—are positive in the current market environment).

In one exemplary embodiment, the synthetic spread is calculated as follows:

synthetic spread=−1*360/N*[S/(S+F)*(1+u*N/360)−1]+e

### Where

S=Reference Spot FX Rate between two currencies (EUR/USD, for example)

F=Reference Forward Points at designated maturity for two currencies (EUR/USD, for example); expressed in decimal form, not number of basis points; e.g., 25 bp would be expressed as 0.0025

u=Interbank Interest Rate with designated maturity for the first currency (USD Libor (ICE), for example)

e=Interbank Interest Rate with designated maturity for the second currency (Euribor (EMMI), for example)

N=number of days between initial FX exchange and final FX exchange for an FX forward trade with the designated maturity

In one exemplary embodiment, the number of days in the calculation period (N) may be equal to the number of days between initial exchange of the two currencies (FX exchange) and final FX exchange for an FX forward trade with the designated maturity.

If the SCCBS uses currencies other than EUR and USD, the terms in the above formula would be based on the analogous and appropriate market data applicable to the currencies used. Designated payment dates may be quarterly, monthly, or at any other suitable interval. For quarterly payments, in the synthetic spread equation above, F would be equal to the Forward Points between the two currencies at three-month maturity, u would be equal to the interbank interest rate for the first currency with a designated maturity of three months, and e would be equal to the interbank interest rate for the second currency with a designated maturity of three months. In one exemplary embodiment of the SCCBS, payments are set at the beginning of the quarter and paid at the end. Specifically, for quarterly payments, the payments made on each payment date are calculated using variables set one quarter prior.

Similarly, for monthly payment dates, these variables would correspond to maturities of one month. It should be understood that any suitable payment date interval could be used in the SCCBS.

In one exemplary embodiment, the SCCBS is effectively a cross-currency basis swap where, on each quarterly roll, the risk for the following quarter is cash settled, leaving only the portion of the swap that starts one quarter in the future remaining. For example, payment at the end of the first quarter represents settlement of the first three months of a one-year swap (calculated at the beginning of the quarter and paid at the end of the quarter). What remains is a forward starting cross currency basis swap, effective one quarter in the future. One quarter later, when the effective date of that swap is live, the first quarter will cash settle, and the pattern repeats until the swap is terminated.

In one exemplary embodiment of the SCCBS, payment dates and termination dates are on IMM (International Monetary Market) dates, which are quarterly dates used in most futures contracts and option contracts as scheduled maturity or termination dates. IMM dates are the third Wednesday of each March, June, September, and December. Payment dates may also be at monthly intervals, or any other suitable time period.

In one exemplary embodiment, the synthetic spread may be calculated using futures rather than forwards. Other changes may also be made to the formula described above for calculating the synthetic spread, while still representing the three-month cross-currency basis spread. In one embodiment of the SCCBS, market tradeable instruments may be used to represent the three-month cross-currency basis spread.

A timeline 204 shows an overview of one implementation of the SCCBS, showing an embodiment where quarterly payments are made during a one-year term. As shown in timeline 204, at the initiation of the SCCBS, when t=0, Party A and Party B do not exchange notionals. Rather, on each quarterly payment date throughout the life of the trade, including on the termination date (for example, t=1 year shown in FIG. 2), the following payments take place: Party A pays a predetermined number of basis points multiplied by a notional to a Party B, and Party B pays the synthetic spread to Party A. In other words, the first party (Party A) pays a fixed amount of interest, while the second party (Party B) pays a variable amount of interest. One advantage of the SCCBS structure is that there are no large back-end cashflows, as are common in cross-currency basis swaps. As a result, the SCCBS results in a much lower credit risk to the parties.

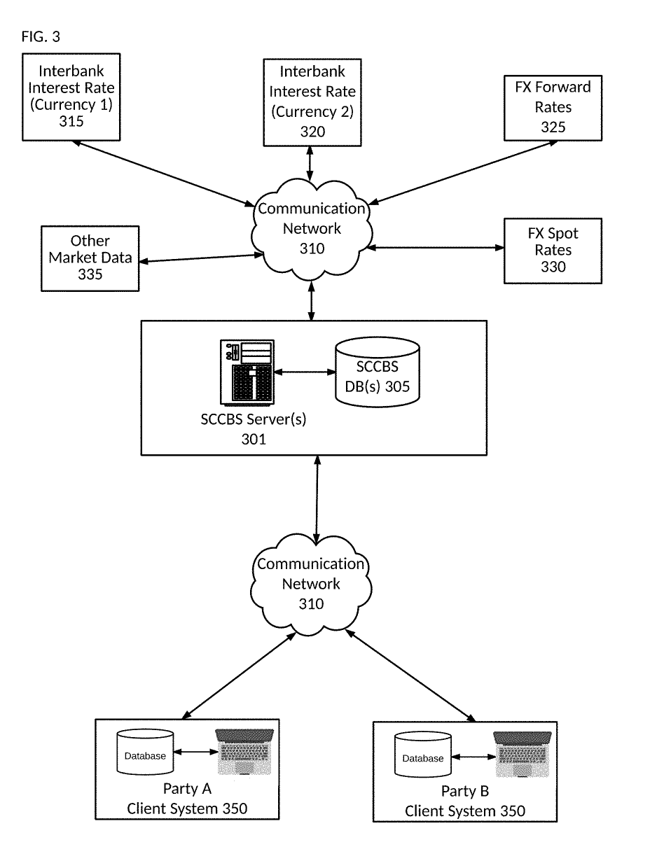

FIG. 3 shows a schematic illustration of data flows between SCCBS components and relevant entities in one embodiment of SCCBS operation. The SCCBS may, in one implementation, comprise an entity including one or more SCCBS servers 301 implementing SCCBS functionality and communicatively coupled to one or more SCCBS databases (“DBs”) 305 configured to store SCCBS data. The SCCBS server 301 may be further coupled by a communication network 310 to one or more market data feeds, including sources for providing current and historical values for an interbank interest rate for a first currency 315 (LIBOR, for example), current and historical values for an interbank interest rate for a second currency 320 (Euribor, for example), FX forward rates 325, FX spot rates 330, and other market data sources 335. For example, these data feeds may be accessed through commercially available services, such as Bloomberg's PhatPipe, Dun & Bradstreet, Reuter's Tib, Triarch, and the like to draw financial data used in the generation and maintenance of SCCBS products. A wide variety of different data may be drawn and is not limited to the examples listed above.

The SCCBS may process received market data to generate swap values and quarterly coupon amounts. As shown in FIG. 3, SCCBS may also be in communication with a plurality of client systems 350 through network 310, to facilitate a trade between two counterparties, for example, Party A and Party B shown in FIG. 3.

In another exemplary embodiment, Party A and Party B, using client systems 350, may receive data directly through communication network 310 via one or more market feeds, and may communicate directly with one another through communication network 310.

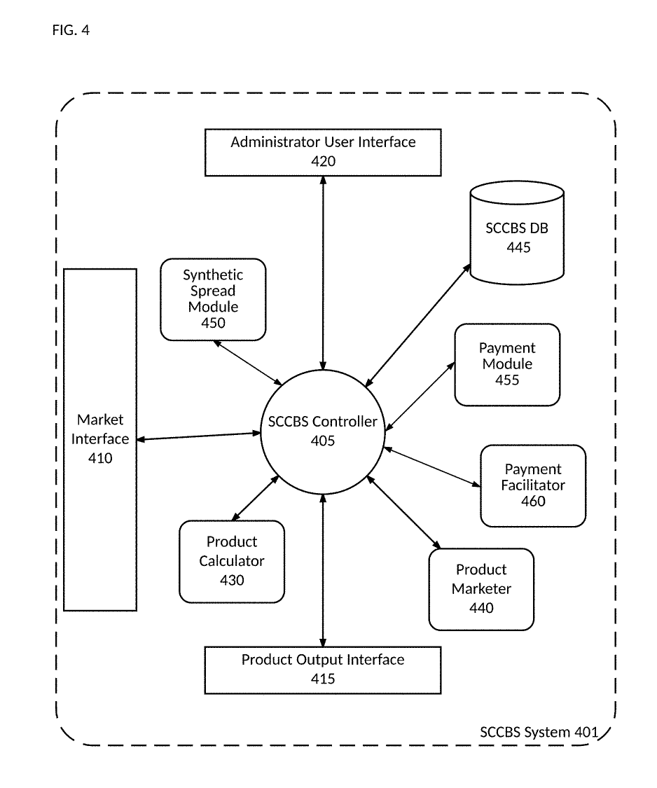

FIG. 4 shows aspects of SCCBS architecture in block-diagram form and data flow between and among SCCBS components in one embodiment of SCCBS operation. A SCCBS system 401 may include a number of operational modules and/or data stores configured to carry out SCCBS features and/or functionality. A SCCBS controller 405 may serve a central role in some embodiments of SCCBS operation, serving to orchestrate the reception, generation and distribution of data and/or instructions to, from, and between SCCBS modules and to allow further analysis of data generated during SCCBS operation. The SCCBS controller 405 may be coupled to one or more operational modules configured to implement various features associated with embodiments of SCCBS operation. SCCBS controller 405 may interface with other components of the system through a communications network.

In one implementation, the SCCBS controller 405 may be coupled to a market interface 410 configured to query and/or draw market data from one or more market data sources; place market orders or otherwise effectuate market transactions; receive confirmations of requested instrument transaction fulfillment; and to perform other suitable functions.

In one implementation, the SCCBS controller 405 may further be coupled to a product output interface 415, which may be configured to generate or request generation of reports containing the values of financial products, provide SCCBS financial products for sale on one or more markets or exchanges; and the like. In one implementation, the SCCBS controller 405 may further be coupled to an administrator user interface 420 configured to provide an interface through which an administrator can monitor and interact with SCCBS system settings, manage data, and the like. For example, in one implementation, a SCCBS administrator may interface with the SCCBS system via the administrator user interface to adjust the values used to calculate quarterly payments or other parameters associated with the product, as may be needed or desired within a given application of the SCCBS.

In one implementation, the SCCBS controller 405 may further be coupled to an product calculator module 430 configured to calculate quarterly coupon values. The SCCBS controller 405 may also interface with a synthetic spread module 450, a payment module 455, and a payment facilitator 460. Synthetic spread module 450 may be configured to calculate the synthetic spread based on criteria such as a spot rate between two currencies, reference rates such as LIBOR and Euribor, and based on other suitable metrics. Payment module 455 may be configured to calculate payments to be exchanged by counterparties to a cross currency basis swap. Payment facilitator 460 may be configured to facilitate the exchange of payment between counterparties.

In one implementation, the SCCBS controller 405 may further be coupled to a product marketer module 440 configured to generate, market, manage, and/or the like financial products and/or instruments with values tied to one or more SCCBS products or trades. In various implementations, the product marketer module may be configured to generate and manage any of a wide variety of different financial products associated with the SCCBS.

In one implementation, the SCCBS controller 405 may further be coupled to one or more databases 445 configured to store a variety of data associated with SCCBS operation in various embodiments. For example, in one implementation, the SCCBS database may include tables for storing information associated with current and/or historical SCCBS quarterly payments, SCCBS linked financial products, market data, transaction orders, transaction histories, and/or the like.

### SCCBS Controller

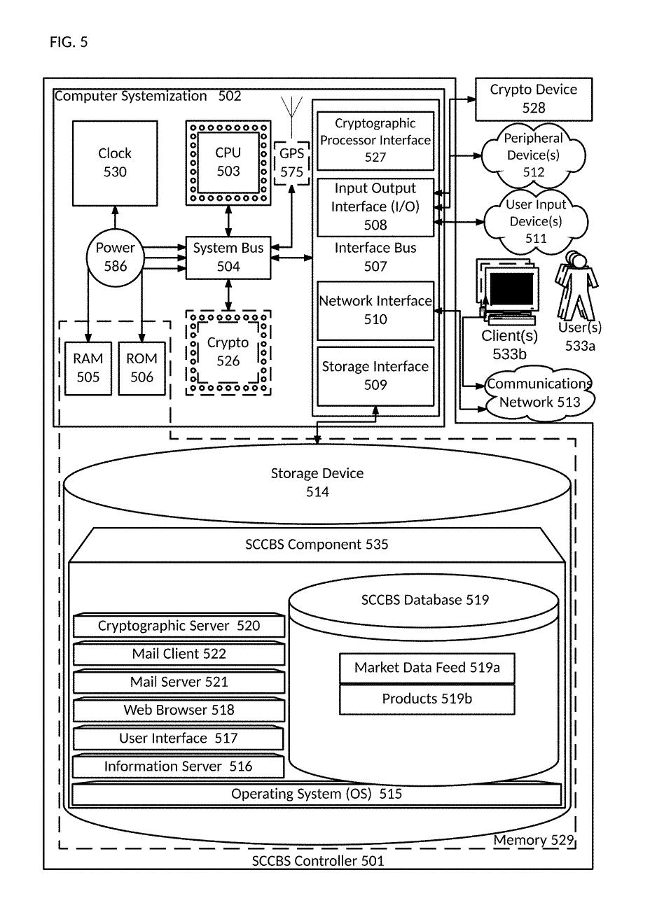

FIG. 5 illustrates inventive aspects of a SCCBS controller 501 in a block diagram. In this embodiment, the SCCBS controller 501 may serve to aggregate, process, store, search, serve, identify, instruct, generate, match, and/or facilitate interactions with a computer a synthetic cross-currency swap and associated financial product generation and management technologies, and/or other related data.

Typically, users, which may be people and/or other systems, may engage information technology systems (e.g., computers) to facilitate information processing. In turn, computers employ processors to process information; such processors 503 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 529 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the SCCBS controller 501 may be connected to and/or communicate with entities such as, but not limited to: one or more users from user input devices 511; peripheral devices 512; an optional cryptographic processor device 528; and/or a communications network 513.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The SCCBS controller 501 may be based on computer systems that may comprise, but are not limited to, components such as: a computer systemization 502 connected to memory 529.

### Computer Systemization

A computer systemization 502 may comprise a clock 530, central processing unit (“CPU(s)” and/or “processor(s)” (these terms are used interchangeable throughout the disclosure unless noted to the contrary)) 503, a memory 529 (e.g., a read only memory (ROM) 506, a random access memory (RAM) 505, etc.), and/or an interface bus 507, and most frequently, although not necessarily, are all interconnected and/or communicating through a system bus 504 on one or more (mother)board(s) 502 having conductive and/or otherwise transportive circuit pathways through which instructions (e.g., binary encoded signals) may travel to effect communications, operations, storage, etc. Optionally, the computer systemization may be connected to an internal power source 586. Optionally, a cryptographic processor 526 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the SCCBS controller and beyond through various interfaces. Should processing requirements dictate a greater amount speed and/or capacity, distributed processors (e.g., Distributed SCCBS), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the SCCBS may be achieved by implementing a microcontroller such as CAST's R8051XC2 microcontroller; Intel's MCS 51 (i.e., 8051 microcontroller); and/or the like. Also, to implement certain features of the SCCBS, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the SCCBS component collection (distributed or otherwise) and/or features may be implemented via the microprocessor and/or via embedded components; e.g., via ASIC, coprocessor, DSP, FPGA, and/or the like. Alternately, some implementations of the SCCBS may be implemented with embedded components that are configured and used to achieve a variety of features or signal processing.

Depending on the particular implementation, the embedded components may include software solutions, hardware solutions, and/or some combination of both hardware/software solutions. For example, SCCBS features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the SCCBS features. A hierarchy of programmable interconnects allow logic blocks to be interconnected as needed by the SCCBS system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the SCCBS may be developed on regular FPGAs and then migrated into a fixed version that more resembles ASIC implementations. Alternate or coordinating implementations may migrate SCCBS controller features to a final ASIC instead of or in addition to FPGAs. Depending on the implementation all of the aforementioned embedded components and microprocessors may be considered the “CPU” and/or “processor” for the SCCBS.

### Power Source

The power source 586 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 586 is connected to at least one of the interconnected subsequent components of the SCCBS thereby providing an electric current to all subsequent components. In one example, the power source 586 is connected to the system bus component 504. In an alternative embodiment, an outside power source 586 is provided through a connection across the I/O 508 interface. For example, a USB and/or IEEE 1394 connection carries both data and power across the connection and is therefore a suitable source of power.

### Interface Adapters

Interface bus(ses) 507 may accept, connect, and/or communicate to a number of interface adapters, conventionally although not necessarily in the form of adapter cards, such as but not limited to: input output interfaces (I/O) 508, storage interfaces 509, network interfaces 510, and/or the like. Optionally, cryptographic processor interfaces 527 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 509 may accept, communicate, and/or connect to a number of storage devices such as, but not limited to: storage devices 514, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 510 may accept, communicate, and/or connect to a communications network 513. Through a communications network 513, the SCCBS controller is accessible through remote clients 533b (e.g., computers with web browsers) by users 533a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed SCCBS), architectures may similarly be employed to pool, load balance, and/or otherwise increase the communicative bandwidth required by the SCCBS controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 510 may be used to engage with various communications network types 513. For example, multiple network interfaces may be employed to allow for the communication over broadcast, multicast, and/or unicast networks.

Input Output interfaces (I/O) 508 may accept, communicate, and/or connect to user input devices 511, peripheral devices 512, cryptographic processor devices 528, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 8o2.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 511 may be card readers, dongles, finger print readers, gloves, graphics tablets, joysticks, keyboards, mouse (mice), remote controls, retina readers, trackballs, trackpads, and/or the like.

Peripheral devices 512 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the SCCBS controller may be embodied as an embedded, dedicated, and/or monitor-less (i.e., headless) device, wherein access would be provided over a network interface connection.

Cryptographic units such as, but not limited to, microcontrollers, processors 526, interfaces 527, and/or devices 528 may be attached, and/or communicate with the SCCBS controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 529. However, memory is a fungible technology and resource, thus, any number of memory embodiments may be employed in lieu of or in concert with one another. It is to be understood that the SCCBS controller and/or a computer systemization may employ various forms of memory 529. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 529 will include ROM 506, RAM 505, and a storage device 514. A storage device 514 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 529 may contain a collection of program and/or database components and/or data such as, but not limited to: operating system component(s) 515 (operating system); information server component(s) 516 (information server); user interface component(s) 517 (user interface); Web browser component(s) 518 (Web browser); database(s) 519; mail server component(s) 521; mail client component(s) 522; cryptographic server component(s) 520 (cryptographic server); the SCCBS component(s) 535; and/or the like (i.e., collectively a component collection). These components may be stored and accessed from the storage devices and/or from storage devices accessible through an interface bus. Although non-conventional program components such as those in the component collection, typically, are stored in a local storage device 514, they may also be loaded and/or stored in memory such as: peripheral devices, RAM, remote storage facilities through a communications network, ROM, various forms of memory, and/or the like.

### Operating System

The operating system component 515 is an executable program component facilitating the operation of the SCCBS controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the SCCBS controller to communicate with other entities through a communications network 513. Various communication protocols may be used by the SCCBS controller as a subcarrier transport mechanism for interaction, such as, but not limited to: multicast, TCP/IP, UDP, unicast, and/or the like.

### Information Server

An information server component 516 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the SCCBS controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the SCCBS database 519, operating systems, other program components, user interfaces, Web browsers, and/or the like.

Access to the SCCBS database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the SCCBS. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the SCCBS as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 517 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 518 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the SCCBS enabled nodes. The combined application may be nugatory on systems employing standard Web browsers.

### Mail Server

A mail server component 521 is a stored program component that is executed by a CPU 503. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the SCCBS.

Access to the SCCBS mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 522 is a stored program component that is executed by a CPU 503. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 520 is a stored program component that is executed by a CPU 503, cryptographic processor 526, cryptographic processor interface 527, cryptographic processor device 528, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the SCCBS may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the SCCBS component to engage in secure transactions if so desired. The cryptographic component facilitates the secure accessing of resources on the SCCBS and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The SCCBS Database

The SCCBS database component 519 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the SCCBS database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the SCCBS database is implemented as a data-structure, the use of the SCCBS database 519 may be integrated into another component such as the SCCBS component 535. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 519 includes several tables 519a-b. A market data table 519a may include fields such as, but not limited to: market_data_feed_ID, asset_ID, asset_symbol, asset_name, spot_price, bid_price, ask_price, LIBOR_value, Euribor_value, FX_spot, FX_forward, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi. A products table 519b may include fields such as, but not limited to: product_ID, product_name, swap_ID(s), terms, restrictions, transaction_history, values, chain_of_title, and/or the like.

In one embodiment, the SCCBS database may interact with other database systems. For example, employing a distributed database system, queries and data access by search SCCBS component may treat the combination of the SCCBS database, an integrated data security layer database as a single database entity.

In one embodiment, user programs may contain various user interface primitives, which may serve to update the SCCBS. Also, various accounts may require custom database tables depending upon the environments and the types of clients the SCCBS may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 519a-b. The SCCBS may be configured to keep track of various settings, inputs, and parameters via database controllers.

The SCCBS database may communicate to and/or with other components in a component collection, including itself, and/or facilities of the like. Most frequently, the SCCBS database communicates with the SCCBS component, other program components, and/or the like. The database may contain, retain, and provide information regarding other nodes and data.

### The SCCBSs

The SCCBS component 535 is a stored program component that is executed by a CPU. In one embodiment, the SCCBS component incorporates any and/or all combinations of the aspects of the SCCBS that was discussed in the previous figures. As such, the SCCBS affects accessing, obtaining and the provision of information, services, transactions, and/or the like across various communications networks.

The SCCBS component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the SCCBS server employs a cryptographic server to encrypt and decrypt communications. The SCCBS component may communicate to and/or with other components in a component collection, including itself, and/or facilities of the like. Most frequently, the SCCBS component communicates with the SCCBS database, operating systems, other program components, and/or the like. The SCCBS may contain, communicate, generate, obtain, and/or provide program component, system, user, and/or data communications, requests, and/or responses.

### Distributed SCCBSs

The structure and/or operation of any of the SCCBS node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the SCCBS controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

To address various issues related to, and improve upon, previous work, the application is directed to SYNTHETIC CROSS-CURRENCY BASIS SWAP APPARATUSES, METHODS, AND SYSTEMS. The entirety of this application (including the Cover Page, Title, Headings, Field, Background, Summary, Brief Description of the Drawings, Detailed Description, Claims, Abstract, Figures, Appendices, and any other portion of the application) shows by way of illustration various embodiments. The advantages and features disclosed are representative; they are not exhaustive or exclusive. They are presented only to assist in understanding and teaching the claimed principles. It should be understood that they are not representative of all claimed inventions. As such, certain aspects of the invention have not been discussed herein. That alternate embodiments may not have been presented for a specific portion of the invention or that further undescribed alternate embodiments may be available for a portion of the invention is not a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the invention. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functionality, features, logical aspects, organizational aspects, structural aspects, topological aspects, and other aspects of the disclosure are not to be considered limitations on the disclosure as defined by the claims or limitations on equivalents to the claims.

Depending on the particular needs and/or characteristics of a SCCBS user, various embodiments of the SCCBS may be implemented that enable a great deal of flexibility and customization. It is to be understood that the apparatuses, methods and systems discussed herein may be readily adapted and/or reconfigured for a wide variety of other applications and/or implementations. For example, aspects of the SCCBS may be adapted for both and/or either long and/or short positions on variance, variances of multiple and/or foreign instruments or assets (e.g., individual stocks, currencies, precious metals, commodities, and/or the like), generating financial products with different positions with respect to variances, and/or the like. Furthermore, aspects of the SCCBS may be configured to generate, administer, and/or manage a wide variety of different financial instruments, securities, and/or the like beyond specific embodiments and/or implementations described in detail herein. For example, indices discussed herein may underlie and/or be linked to any of a wide variety of financial products, derivatives, instruments, and/or the like, such as but not limited to: equities, debts, derivatives, notes (e.g., structured notes), stocks, preferred shares, bonds, treasuries, debentures, options, futures, swaps, rights, warrants, commodities, currencies, funds, long and/or short positions, ETFs, ETNs, insurance and/or risk transfer agreements, annuities, and/or other assets or investment interests. The SCCBS may be further adapted to other implementations and/or investment, finance and/or risk management applications.

The invention claimed is:

1. A system for executing a synthetic cross-currency basis swap, the system comprising:
a synthetic swap controller having a processor and a memory, the synthetic swap controller being configured to interface with a communications network, wherein the controller is further configured to determine a notional value for the swap, the notional value being denominated in a first currency;
a synthetic spread module interfacing with the controller and being configured to calculate a synthetic spread based on a spot rate between the first currency and a second currency, a first reference rate for the first currency, and a second reference rate for the second currency;
a payment module interfacing with the controller and being configured to calculate a first payment to be paid by a first party to the swap by multiplying the notional value by a predetermined number of basis points, and being configured to calculate a second payment to be paid by a second party to the swap by multiplying the notional value by the synthetic spread; and
a payment facilitator configured to facilitate the exchange of payment between the first party and the second party.

2. The system of claim 1, wherein the synthetic spread module is further configured to use forward points added to or subtracted from the spot rate between the first currency and the second currency in calculating the synthetic spread.

3. The system of claim 1, wherein the synthetic spread module is further configured to use futures when calculating the synthetic spread.

4. The system of claim 1, wherein the synthetic spread module is configured to calculate the synthetic spread using the following formula:
synthetic spread=−1*360/N*[S/(S+F)*(1+u*N/360)−1]+e
where S=spot rate, F=forward points, u=first reference rate for the first currency, e=second reference rate for the second currency, and N=number of days in a time period for the swap.

5. The system of claim 1, wherein the payment module is further configured to calculate the first payment and the second payment on a quarterly basis.

6. The system of claim 1, wherein the payment module is further configured to calculate the first payment and the second payment on International Monetary Market Dates.

7. The system of claim 1, wherein the payment facilitator is further configured to facilitate payment between the first party and the second party in a single currency.

8. The system of claim 1, wherein the synthetic spread module is further configured to use market-tradeable instruments in determining the synthetic spread.

9. A processor-implemented method for executing a synthetic cross-currency basis swap, the method comprising:
determining, using a processor, a notional value for the swap, the notional value being denominated in a first currency;
calculating, using the processor, a synthetic spread based on a spot rate between the first currency and a second currency, a first reference rate for the first currency, and a second reference rate for the second currency;
calculating, using the processor, a first payment to be paid by a first party to the swap by multiplying the notional value by a predetermined number of basis points;
calculating, using the processor, a second payment to be paid by a second party to the swap by multiplying the notional value by the synthetic spread; and
facilitating, using the processor, an exchange of payment between the first party and the second party.

10. The method of claim 9, wherein calculating the synthetic spread further comprises using forward points added to or subtracted from the spot rate between the first currency.

11. The method of claim 9, of claim 1, wherein calculating the synthetic spread further comprises using futures.

12. The method of claim 9, wherein the synthetic spread is calculated using the following formula:
synthetic spread=−1*360/N*[S/(S+F)*(1+u*N/360)−1]+e
where S=spot rate, F=forward points, u=first reference rate for the first currency, e=second reference rate for the second currency, and N=number of days in a time period for the swap.

13. The method of claim 12, wherein the number of days in the calculation period is equal to the number of days between an initial FX exchange and a final FX exchange for a 3-month FX forward.

14. The method of claim 9, wherein the first payment and the second payment are calculated on a quarterly basis.

15. The method of claim 9, wherein the first payment and the second payment are calculated on International Monetary Market Dates.

16. The method of claim 9, wherein facilitating the exchange of payment between the first party and the second party comprises facilitating payment in a single currency.

17. The method of claim 9, further comprising using market-tradeable instruments to calculate the synthetic spread.

18. The method of claim 9, wherein the first currency is U.S. dollars, the second currency is Euros, the first reference rate is LIBOR, and the second reference rate is Euribor.

19. A processor-readable tangible physical medium storing processor-generated instructions to:
determine a notional value for the swap, the notional value being denominated in a first currency;
calculate a synthetic spread based on a spot rate between the first currency and a second currency, a first reference rate for the first currency, and a second reference rate for the second currency;
calculate a first payment to be paid by a first party to the swap by multiplying the notional value by a predetermined number of basis points;
calculate a second payment to be paid by a second party to the swap by multiplying the notional value by the synthetic spread; and
facilitate an exchange of payment between the first party and the second party.
